(19) United States
(12) Patent Application Publication
(10) Pub. No.: US 2005/0069281 A1
(43) Pub. Date: Mar. 31, 2005

(54) Recording apparatus and recording method

(76) Inventor: Hirotsugu Satoh, Kanagawa (JP)

Correspondence Address: Mark J. Thronson, Esq.;DICKSTEIN SHAPIRO MORIN & OSHINSKY LLP, 2101 L Street NW, Washington, DC, 20037-1526, US

(21) Appl. No.: 10/943,205

(22) Filed: Sep. 17, 2004

Related U.S. Application Data
(63) Continuation of application No. PCT/JP04/03411, filed on Mar. 15, 2004.

(30) Foreign Application Priority Data
Aug. 21, 2003 (JP) 2003-297804

(51) Int. Cl. H04N 5/781

(52) U.S. Cl. 386/46; 386/125

(57) ABSTRACT

A recording apparatus includes an inputting part for inputting image signals, a generating part for generating various encoded image data encoded with various encoding formats from the image signals input from the inputting part, and a recording part for recording the various encoded image data generated from the generating part.

### CROSS-REFERENCE TO RELATED APPLICATION

This application is a U.S. continuation application filed under 35 USC 111 (a) claiming benefit under 35 USC 120 and 365 (c) of PCT application JP 2004/003411, filed on Mar. 15, 2004, which claims priority to Application Ser. No. 2003-297804, filed in Japan on Aug. 21, 2003. The foregoing applications are hereby incorporated herein by reference.

### BACKGROUND OF THE INVENTION

1. Field of the Invention

The present invention relates to a recording apparatus and a recording method for recording input image signals, and encoded image signals and audio signals to various recording media, for example, a hard disk, an optical disk, or a memory card.

2. Description of the Related Art

As a conventional recording apparatus for generating and recording images with a portable apparatus, there are mainly two types of recording apparatuses.

A. A recording apparatus for re-encoding an image in a memory device connected to a computer by using an encoding method for containing the image within the capacity of a memory card, by using software applicable for the computer, and then transferring (recording) the encoded image to the memory card via a memory read/write apparatus (recording apparatus A). The image can be reproduced by inserting the memory card, having the image recorded thereto by the recording apparatus, into the portable apparatus.

B. A recording apparatus for automatically or manually recording images/sound during output of an image by connecting an output terminal of a conventional VTR, for example, to an image recording apparatus, which is exclusively used for a memory card, and is provided with an apparatus that encoding images to size suitable for the capacity of a memory card, or to a portable apparatus main body having a similar function (recording apparatus B). The image can be reproduced by inserting the memory card, having the image recorded thereto by the recording apparatus, into the portable apparatus.

In another conventional recording apparatus (for example, as shown in Japanese Laid-Open Patent Application No.2003-32617), the recording apparatus includes a first encoder that compresses data of at least one of an image signal or an audio signal (target data) with a first compression format (method) and generates the compressed data (first compressed data), a second encoder that compresses the target data with a second compression format (method), which is different from the first compression format, and generates the compressed data (second compressed data), and a recording control part that records the first and second compressed data to a recording medium.

Nevertheless, the conventional recording apparatuses have the following problems.

In order to reproduce an image with a portable apparatus by employing the recording apparatus A, the recording apparatus A is required to decode encoded image data and then re-encode the decoded data, thereby raising a problem of time consumption. Furthermore, in a case where an image desired for reproduction is not in the memory device connected to the computer, image data is required to be read into the memory device of the computer by connecting the computer with a reading apparatus, thereby requiring a complex process.

Although the recording apparatus B does not require connection to a computer, image data that exceeds the capacity of the memory card cannot be recorded since the recording apparatus B records image data directly to the memory card. In order to record images for a long period, it is necessary to prepare several memory cards and to manually replace the memory cards, thereby requiring a complex process.

Furthermore, since the recording apparatus shown in Japanese Laid-Open Patent Application No.2003-32617 uses a first encoder dedicated to compress data with a first compression format and a second encoder dedicated to compress data with a second compression format, it is difficult to change compression format (encoding format).

### SUMMARY OF THE INVENTION

It is a general object of the present invention to provide a recording apparatus and a recording method that substantially obviate one or more of the problems caused by the limitations and/or disadvantages of the related art.

Features and advantages of the present invention will be set forth in the description which follows, and in part will become apparent from the description and the accompanying drawings, or may be learned by practice of the invention according to the teachings provided in the description. Objects as well as other features and advantages of the present invention will be realized and attained by a recording apparatus and a recording method particularly pointed out in the specification in such full, clear, concise, and exact terms as to enable a person having ordinary skill in the art to practice the invention.

To achieve these and other advantages and in accordance with the purpose of the invention, as embodied and broadly described herein, the invention provides a recording apparatus including: an inputting part for inputting image signals; a generating part for generating various encoded image data encoded with various encoding formats from the image signals input from the inputting part; and a recording part for recording the various encoded image data generated from the generating part.

Furthermore, the present invention provides a recording apparatus including: an inputting part for inputting image signals and audio signals; a generating part for generating various encoded image data and various encoded audio data encoded with various encoding formats from the image signals and audio signals input from the inputting part; and a recording part for recording the various encoded image data and the various encoded audio data generated from the generating part.

Furthermore, the present invention provides a recording apparatus including: an inputting part for inputting image signals; a generating part for generating various encoded image data encoded with various encoding formats from the image signals input from the inputting part; a first recording part for recording the various encoded image data generated from the generating part; and a second recording part for recording a designated one of the various encoded image data generated from the generating part.

In the recording apparatus according to an embodiment of the present invention, the first recording part may be a hard disk apparatus, and the second recording part may be an optical disk apparatus.

In the recording apparatus according to an embodiment of the present invention, the first recording apparatus may be a hard disk apparatus, and the second recording apparatus may be a memory card apparatus.

In the recording apparatus according to an embodiment of the present invention, the first recording part may be a hard disk apparatus, and the second recording part may be a USB memory apparatus.

In the recording apparatus according to an embodiment of the present invention, the first and second recording apparatuses may be optical disk apparatuses.

In the recording apparatus according to an embodiment of the present invention, the first recording part may be an optical disk apparatus, and the second recording part may be a memory card apparatus.

In the recording apparatus according to an embodiment of the present invention, the first recording part may be an optical disk apparatus, and the second recording part may be a USB memory apparatus.

Furthermore, the present invention provides a recording apparatus including: an inputting part for inputting image signals and audio signals; a generating part for generating various encoded image data and various encoded audio data encoded with various encoding formats from the image signals and the audio signals input from the inputting part; a first recording part for recording the various encoded image data and the various encoded audio data generated from the generating part; and a second recording part for recording a designated one of the various encoded image data and the various encoded audio data generated from-the generating part.

Furthermore, the present invention provides a recording method including the steps of: a) inputting image signals; b) generating various encoded image data encoded with various encoding formats from the image signals input in step a); and c) recording the various encoded image data generated in step b).

Furthermore, the present invention provides a recording method including the steps of: a) inputting image signals and audio signals; b) generating various encoded image data and various encoded audio data encoded with various encoding formats from the image signals and audio signals input in step a); and c) recording the various encoded image data and the various encoded audio data generated in step c).

Furthermore, the present invention provides a recording method including the steps of: a) inputting image signals; b) generating various encoded image data encoded with various encoding formats from the image signals input in step a); c) recording the various encoded image data generated in step b) to a first recording part; and d) recording a designated one of the various encoded image data generated in step b) to a second recording part.

In the recording method according to an embodiment of the present invention, the first recording part may be a hard disk apparatus, and the second recording part may be an optical disk apparatus.

In the recording method according to an embodiment of the present invention, the first recording apparatus may be a hard disk apparatus, and the second recording apparatus may be a memory card apparatus.

In the recording method according to an embodiment of the present invention, the first recording part may be a hard disk apparatus, and the second recording part may be a USB memory apparatus.

In the recording method according to an embodiment of the present invention, the first and second recording apparatuses may be optical disk apparatuses.

In the recording method according to an embodiment of the present invention, the first recording part may be an optical disk apparatus, and the second recording part may be a memory card apparatus.

In the recording method according to an embodiment of the present invention, the first recording part may be an optical disk apparatus, and the second recording part may be a USB memory apparatus.

Furthermore, the present invention provides a recording method including the steps of: a) inputting image signals and audio signals; b) generating various encoded image data and various encoded audio data encoded with various encoding formats from the image signals and the audio signals input in step a); c) recording the various encoded image data and the various encoded audio data generated in step b) to a first recording part; and d) recording a designated one of the various encoded image data and the various encoded audio data generated in step b) to a second recording part.

Other objects and further features of the present invention will be apparent from the following detailed description when read in conjunction with the accompanying drawings.

### BRIEF DESCRIPTION OF THE DRAWINGS

FIG. 1 is a block diagram showing an exemplary internal composition of an image recording/reproducing apparatus according to a first embodiment of the present invention;

FIG. 2 is front external view of an image recording/reproducing apparatus according to an embodiment of the present invention;

FIG. 3 is a flowchart showing a process of simultaneously recording image/audio data with the image recording/reproducing apparatus according to the first embodiment of the present invention;

FIGS. 4A-4C are schematic diagrams for describing an outputting operation with respect to the memory device of the image recording/reproducing apparatus according to an embodiment of the present invention;

FIG. 5 is a block diagram showing an exemplary internal composition of an image recording/reproducing apparatus according to a second embodiment of the present invention;

FIG. 6 is a flowchart showing a process of simultaneously recording image/audio data with the image recording/reproducing apparatus according to the second embodiment of the present invention; and

FIG. 7 is a flowchart for describing a preset recording operation with the image recording/reproducing apparatus according to the first embodiment of the present invention shown in FIG. 1.

### DESCRIPTION OF THE PREFERRED EMBODIMENTS

In the following, embodiments of the present invention will be described in detail with reference to the accompanying drawings.

[First Embodiment]

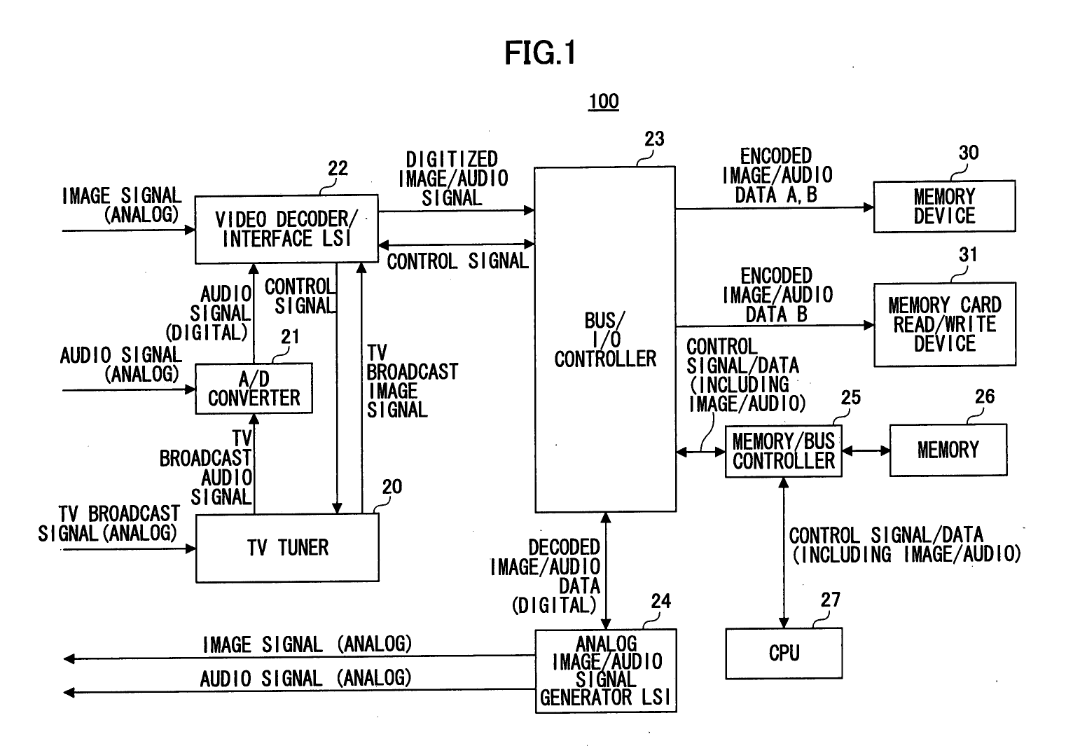

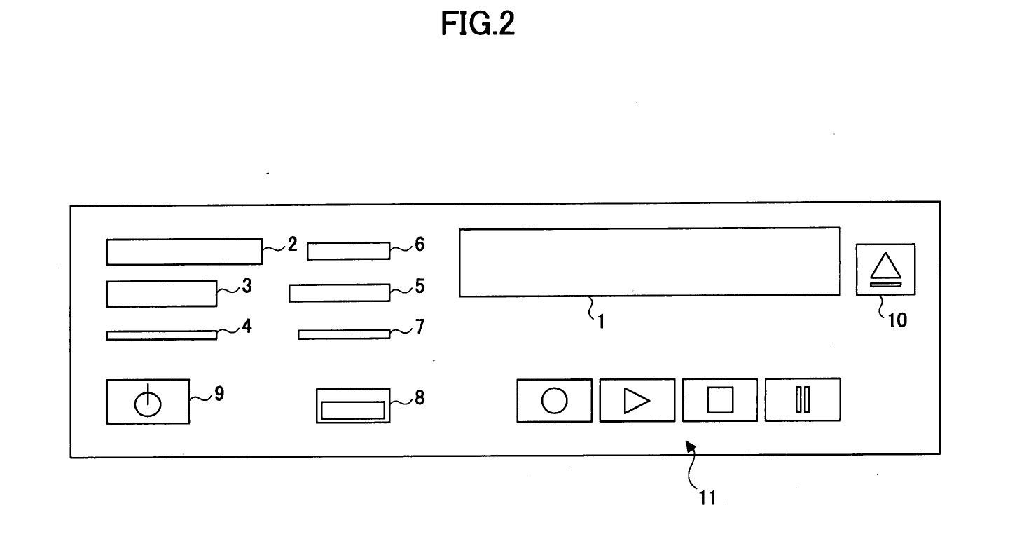

FIG. 1 is a block diagram showing an internal composition of an image recording/reproducing apparatus (recording apparatus) 100 according to a first embodiment of the present invention, and FIG. 2 is an external view showing the image recording/reproducing apparatus (recording apparatus) 100 according to the first embodiment of the present invention.

The image recording/reproducing apparatus 100 according to the first embodiment of the present invention includes a memory device (memory apparatus), such as, a hard disk apparatus, an optical disk apparatus (optical disk drive), a PC card apparatus (PC card read/write apparatus), a compact flash (registered trademark) card apparatus (compact flash card read/write apparatus), a smart media apparatus (smart media read/write apparatus), an SD memory card/multimedia card apparatus (SD memory card/multimedia read/write apparatus), a memory stick apparatus (a memory stick read/write apparatus), an xD picture card apparatus (xD picture card read/write apparatus), or a USB memory apparatus.

Here, the hard disk apparatus is, for example, a magnetic disk apparatus which records/reproduces information to/from a hard disk.

The optical disk apparatus is, for example, an apparatus which reads and reproduces information from a read-only optical disk such as a CD, a CD-ROM disk, or a DVD-ROM disk, and/or an apparatus which reads, reproduces, and records information from/to a recordable optical disk such as a CD-R disk, a CD-RW disk, a DVD-R disk, a DVD+R disk, a DVD-RW disk, a DVD+RW disk, or a DVD-RAM disk.

The PC card apparatus is, for example, an apparatus which records and reproduces information to/from a PC card.

The compact flash card apparatus is, for example, an apparatus which records and reproduces information to/from a compact flash card.

The smart media apparatus is, for example, an apparatus which records and reproduces information to/from smart media. The SD memory card/multimedia card apparatus is, for example, an apparatus which records and reproduces information to/from an SD memory card and a multimedia card.

The memory stick apparatus is, for example, an apparatus which records and reproduces information to/from a memory stick. The xD picture card apparatus is, for example, an apparatus which records and reproduces information to/from an xD picture card.

The USB memory apparatus is, for example, an apparatus which records and reproduces information to/from a USB memory.

As shown in FIG. 2, the front surface of the image recording/reproducing apparatus 100 according to the first embodiment of the present invention is provided with, for example, a disk tray 1 for mounting an optical disk and inserting the optical disk to the optical disk apparatus, a PC card slot 2 for inserting and attaching a PC card to the PC card apparatus, a compact flash card slot 3 for inserting and attaching a compact flash card to the compact flash apparatus, a smart media slot 4 for inserting and attaching smart media to the smart media apparatus, an SD memory card/multimedia card slot 5 for inserting and attaching an SD memory card and/or a multimedia card to the SD memory card/multimedia card apparatus, a memory stick slot 6 for inserting and attaching a memory stick to the memory stick apparatus, and an xD picture card slot 7 for inserting and attaching an xD picture card to the xD picture apparatus.

Furthermore, the front surface of the image recording/reproducing apparatus 100 according to the first embodiment of the present invention is provided with, for example, a USB port 8 for inserting and attaching a USB memory to the USB memory apparatus, a power button 9 for turning the image recording/reproducing apparatus 100 on and off, a disk eject button for taking the optical disk in and out of the disk tray 1, an instruction button group 11 for instructing the optical disk apparatus to execute operations, such as, play (reproduce), record, stop, and pause.

As an alternative of the SD memory card/multimedia card apparatus, the image recording/reproducing apparatus 100 may be provided with an SD memory card apparatus which records and reproduces information to/from an SD memory card, and a multimedia card apparatus which records and reproduces information to/from a multimedia card, and have its front surface provided with slots corresponding to the SD memory card apparatus and the multimedia card apparatus, respectively.

The above-described PC card apparatus, the compact flash card apparatus, the smart media apparatus, the SD memory card apparatus, the multimedia card apparatus, the memory stick apparatus, and the xD picture card apparatus are hereinafter generically referred to as a memory card apparatus, and the PC card slot 2, the compact flash card slot 3, the smart media slot 4, the SD memory card/multimedia card slot 5, the memory stick slot 6, and the xD picture card slot 7 are hereinafter generically referred to as a memory card slot.

As shown in FIG. 1, the image recording/reproducing apparatus 100 according to the first embodiment of the present invention has inside, for example, a television (TV) tuner 20, an A/D converter 21, a video decoder/interface LSI 22, a bus/I/O controller 23, an analog image/audio signal generator LSI 24, a memory/bus controller 25, a memory 26, a CPU 27, a memory device (memory apparatus) 30, and a memory card read/write device (memory card read/write apparatus) 31.

The TV tuner 20 receives analog TV broadcast waves and inputs therein TV broadcast signals. The TV tuner 20 then generates TV broadcast image signals (analog image signals) and TV broadcast audio signals (analog audio signals) in accordance with the TV broadcast signals. The generated TV broadcast image signals and the TV broadcast audio signals are output to the video decoder/interface LSI 22 and the A/D converter 21, respectively.

The A/D converter 21 converts the TV broadcast audio signals from the TV tuner 20 and analog audio signals input from the external into digital audio signals, and outputs the digital audio signals to the video decoder/interface LSI 22.

The video decoder/interface LSI 22 converts the TV broadcast image signals from the TV tuner 20 and analog image signals input from the external into digital audio signals, and outputs the digital image signals or the digital audio signals from the A/D converter 21 to the bus/I/O controller 23.

The bus/I/O controller 23, having an interface, for example, IDE/ATAPI, outputs image data of the digital image signals from the video decoder/interface LSI 22 or audio data of the digital audio signals to the memory/bus controller 25. Furthermore, the bus/I/O controller 23 outputs decoded image data and audio data from the memory/bus controller 25 to the analog image/audio signal generator LSI 24. Furthermore, bus/I/O controller 23 outputs encoded image data and encoded audio data, which are encoded from the controls of the CPU 27 via the memory/bus controller 25, to the memory device 30 or to the memory card read/write device 31, thereby writing (recording) the encoded image/audio data to the memory device 30 or to the memory card read/write device 31. Furthermore, the bus/I/O controller 23 reads out the encoded image/audio data in the memory device 30 or the memory card read/write device 31 and outputs the encoded image/audio data to the memory/bus controller 25.

The analog image/audio signal generator LSI 24 receives decoded image/audio data from the bus/I/O controller 23, converts the decoded image/audio data to analog signals to be generated as analog image signals and analog audio signals, and outputs the analog image signals to a monitor (display) such as a CRT monitor, or a LCD monitor, and analog audio signals to a speaker.

The memory bus controller 25 writes the image data or audio data from the bus/I/O controller 23 to the memory 26. Furthermore, the memory bus controller 25 reads decoded image data or audio data decoded in the memory 26, and outputs the decoded data to the bus/I/O controller 23.

The memory 26 is a memory device which temporarily stores image data and audio data for allowing the CPU 27 to perform encoding and decoding of the stored image/audio data.

The CPU 27, which has inside a memory (e.g. ROM, not shown) stored with a program for performing a recording method of the present invention as well as other programs, executes the program for performing the recording method of the present invention. By executing the program, the CPU performs an overall control of the image recording/reproducing apparatus 100 including processes of generating various types of encoded image/audio data by encoding the image/audio data in the memory 26 by employing various types of encoding processes (formats), decoding the encoded image/audio data, recording the encoded image/audio data to the memory device 30 or the memory card read/write device 31 by controlling the bus/I/O controller 23 and the memory/bus controller 25, reading out the encoded image/audio data in the memory device 30 or the memory card read/write device 31, and storing the read out encoded image/audio data in the memory 26.

The memory device 30, serving as a memory (unit) of, for example, the hard disk apparatus, and/or the optical disk apparatus, records encoded image/audio data to a recording medium (or recording media), and reads out and outputs the encoded image/audio data recording to the recording medium (recording media).

The memory card read/write apparatus 31 is connected to the bus/I/O controller 23 via an interface such as USB. The memory card read/write apparatus 31 serving as a memory unit of, for example, the optical disk apparatus, the PC card apparatus, the compact flash card apparatus, the smart media apparatus, the SD memory card/multimedia card apparatus, the memory stick apparatus, the xD picture card apparatus, and/or the USB memory apparatus, records encoded image/audio data to a recording medium (or recording media), and reads out and outputs the encoded image/audio data recording to the recording medium (recording media).

Accordingly, the TV tuner 20, the A/D converter 21, the video decoder/interface LSI 22, and the bus/I/O controller 23 function as inputting parts.

Furthermore, the memory/bus controller 25, the memory 26, and the CPU 27 function as generating parts. Furthermore, the bus/I/O controller 23, the memory bus 25, and the CPU 27 function as recording control parts.

Furthermore, the memory device 30 and the memory card read/write device 31 serve as recording parts. More particularly, the memory device 30 serve as a first memory unit and the memory card read/write device 31 serve as a second recording unit.

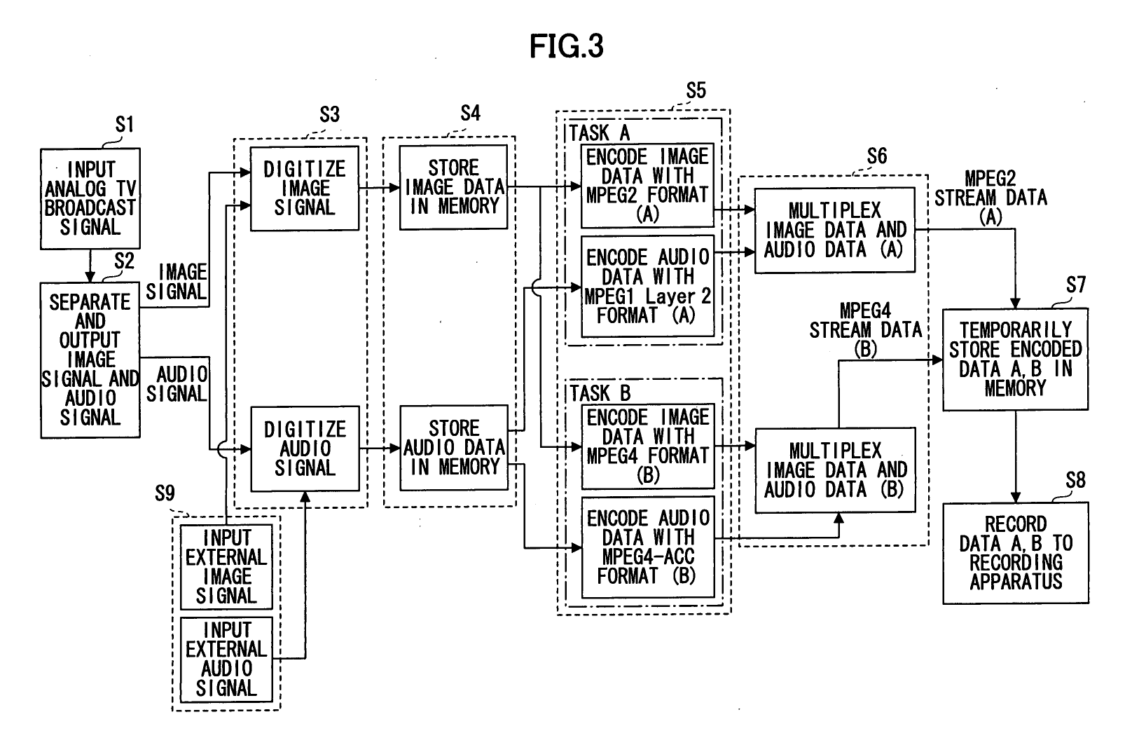

Next, a process for simultaneously recording image and audio with the image recording/reproducing apparatus 100 according to the first embodiment of the present invention (see FIG. 1) is described with reference to the flowchart shown in FIG. 3.

In accordance with the control of the CPU 27, analog TV broadcast signals are input when the TV tuner 20 receives analog TV broadcast waves (Step S1). Then, by separating the analog TV broadcast signals into analog image signals and analog audio signals, analog image signals and analog audio signals are generated. Then, the analog image signals are output to the video decoder/interface LSI 22 and the analog audio signals are output to the A/D converter 21 (Step S2).

Then, in a digitizing step (Step S3), the A/D converter 21 converts the analog audio signals to digital audio signals and outputs the digital audio signals to the video decoder/interface LSI 22. In addition, the video decoder/interface LSI 22 converts the analog image signals to digital image signals and outputs the digital image signals along with the digital audio signals to the bus/I/O controller 23. Then, the bus/I/O controller 23 and the memory/bus controller 25 respectively store image data of the digital image signal and audio data of the digital audio signal in the memory 26 (Step S4).

Then, in Step S5, the image data in the memory 26 is encoded with an MPEG 2 format, and the audio data in the memory 26 is encoded with an MPEG 1 Layer 2 format (TASK A), furthermore, the image data in the memory 26 is encoded with an MPEG 4 format, and the audio data in the memory 26 is encoded with an MPEG 4-ACC format (TASK B).

Then, in Step S6, the image data encoded with the MPEG 2 format and the audio data encoded with the MPEG 1 Layer 2 format are multiplexed to generate an MPEG 2 stream data (data A), furthermore, the image data encoded with MPEG 4 format and the audio data encoded with MPEG 4-ACC format are multiplexed to generate an MPEG 4 stream data (data B). Then, in Step 7, data A (MPEG 2 stream data) and data B (MPEG 4 stream data) are temporarily stored in the memory 26.

Accordingly, by simultaneously encoding image data with various (plural) types of encoding formats (in this example, MPEG 2 format and MPEG 4 format), and simultaneously encoding audio data with various (plural) types of encoding formats (in this example, MPEG 1 Layer 2 and MPEG 4-ACC format), image data and audio data encoded in various (plural) types can be generated.

Then, in Step S8, data A and B are alternately recorded in order, in uniform spans of time, to the memory device 30. That is, various types of encoded image/audio data are recorded to the memory device 30.

In a case where both the memory device 30 and the memory card read/write device 31 are set to have the encoded image/audio data recorded thereto, various types of encoded image/audio data are recorded to the memory device 30 and the memory card read/write device 31.

Furthermore, in a case of recording the encoded image/audio data to the memory card read/write device 31, the user may selectively read out a particular encoded image/audio data from the recording device 30, and transfer the particular encoded image/audio data to the memory card read/write device 31 to be recorded thereat. Furthermore, the user may also selectively read out a particular encoded image/audio data from the memory 26, and transfer the particular encoded image/audio data to the memory card read/write device 31 to be recorded thereat.

The user may selectively transfer and record the encoded image/audio data to any one of the optical disk, the PC card apparatus, the compact flash card apparatus, the smart media apparatus, the SD memory card/multimedia card apparatus, the memory stick apparatus, the xD picture card apparatus, and the USB memory apparatus (serving as the memory card read/write device 31) or an apparatus to which a recording medium is installed. Furthermore, the encoded image/audio data may be transferred and recorded to all of the above-described apparatuses.

As an alternative of executing Steps S1 and S2, image signals and audio signals may be input from the external. In this case, after the image signals and audio signals are digitized (Step S3), the above-described Steps S4 to S8 are executed.

Next, a process of simultaneously reproducing image and audio with the image recording/reproducing apparatus 100 according to the first embodiment of the present invention (see FIG. 1) is described.

In accordance with the control of the CPU 27, encoded image data and audio data are read out from the memory device 30 or the memory card read/write device 31, and is transferred to the memory 26 via the bus/I/O controller 23 and the memory/bus controller 25. The encoded image/audio data transferred to the memory 26 are decoded into digital image/audio data by using a program. Then, the analog image/audio signal generator LSI 24 converts the decoded digital image/audio data into analog image data for enabling display on a display (e.g. monitor) and analog audio data for enabling output from a speaker. Thereby, the converted analog image data and audio data are output for allowing images to be displayed on the display and sound to be output from the speaker.

Next, a process for recording image(s) using various (plural) encoded data with the image recording/reproducing apparatus 100 according to the first embodiment of the present invention (see FIG. 1) is described.

In accordance with the control of the CPU 27, analog TV broadcast signals are input when the TV tuner 20 receives analog TV broadcast signals. Then, by separating analog image signals from the analog TV broadcast signals, analog image signals are generated. Then, the analog image signals are output to the video decoder/interface LSI 22. In addition, analog image signals may be input directly to the video decoder/interface LSI 22.

Then, in a digitizing step, the video decoder/interface LSI 22 converts the analog image signals to digital image signals and outputs the digital image signals to the bus/I/O controller 23. Then, the bus/I/O controller 23 and the memory/bus controller 25 store image data of the digital image signal in the memory 26.

Then, the image data in the memory 26 is encoded with an MPEG 2 format (TASK A), furthermore, the image data in the memory 26 is encoded with an MPEG 4 format (TASK B). Then, the image data encoded with the MPEG 2 format and the image data encoded with the MPEG 4 format are recorded in order to the memory device 30.

Accordingly, image data is encoded with various (plural) types of encoding formats (in this example, MPEG 2 format and MPEG 4 format), to thereby allow various types of encoded image data to be recorded to the memory device 30.

In a case where both the memory device 30 and the memory card read/write device 31 are set to have the encoded image data recorded thereto, various types of encoded image data are recorded to the memory device 30 and the memory card read/write device 31.

Furthermore, in a case of recording the encoded image data to the memory card read/write device 31, the user may selectively read out a particular encoded image data from the recording device 30, and transfer the particular encoded image data to the memory card read/write device 31 to be recorded thereat. Furthermore, the user may also selectively read out a particular encoded image data from the memory 26, and transfer the particular encoded image data to the memory card read/write device 31 to be recorded thereat.

The user may selectively transfer and record the encoded image data to any one of the optical disk, the PC card apparatus, the compact flash card apparatus, the smart media apparatus, the SD memory card/multimedia card apparatus, the memory stick apparatus, the xD picture card apparatus, and the USB memory apparatus (serving as the memory card read/write device 31) or an apparatus to which a recording medium is installed.

Furthermore, the encoded image data may be transferred and recorded to all of the above-described apparatuses.

Next, a process of reproducing image(s) with the image recording/reproducing apparatus 100 according to the first embodiment of the present invention (see FIG. 1) is described.

In accordance with the control of the CPU 27, encoded image data is read out from the memory device 30 or the memory card read/write device 31, and is transferred to the memory 26 via the bus/I/O controller 23 and the memory/bus controller 25. The encoded image data transferred to the memory 26 is decoded into digital image data by using a program. Then, the analog image signal generator LSI 24 converts the decoded digital image data into analog image data for enabling display on a display (e.g. monitor). Thereby, the converted analog image data is output for allowing images to be displayed on the display.

Next, a process for recording audio using various (plural) encoded data with the image recording/reproducing apparatus 100 according to the first embodiment of the present invention (see FIG. 1) is described.

In accordance with the control of the CPU 27, analog TV broadcast signals are input when the TV tuner 20 receives analog TV broadcast signals. Then, by separating analog audio signals from the analog TV broadcast signals, analog image signals are generated. Then, the analog audio signals are output to the A/D converter 21. In addition, analog audio signals may be input directly to the A/D converter 21.

Then, in a digitizing step, the A/D converter 21 converts the analog audio signals to digital audio signals and outputs the digital audio signals to the video decoder/interface LSI 22. Then, the bus/I/O controller 23 and the memory/bus controller 25 store audio data of the digital audio signal in the memory 26.

Then, the audio data in the memory 26 is encoded with an MPEG 1 Layer 2 format (TASK A), furthermore, the audio data in the memory 26 is encoded with an MPEG 4-ACC format (TASK B). Then, the audio data encoded with the MPEG 1 Layer 2 format and the audio data encoded with the MPEG 4-ACC format are recorded in order, to the memory device 30.

Accordingly, audio data is encoded with various (plural) types of encoding formats (in this example, MPEG 1 Layer 2 format and MPEG 4-ACC format), to thereby allow various types of encoded audio data to be recorded to the memory device 30.

In a case where both the memory device 30 and the memory card read/write device 31 are set to have the encoded audio data recorded thereto, various types of encoded audio data are recorded to the memory device 30 and the memory card read/write device 31.

Furthermore, in a case of recording the encoded audio data to the memory card read/write device 31, the user may selectively read out a particular encoded audio data from the recording device 30, and transfer the particular encoded audio data to the memory card read/write device 31 to be recorded thereat. Furthermore, the user may also selectively read out a particular encoded audio data from the memory 26, and transfer the particular encoded audio data to the memory card read/write device 31 to be recorded thereat.

The user may selectively transfer and record the encoded audio data to any one of the optical disk, the PC card apparatus, the compact flash card apparatus, the smart media apparatus, the SD memory card/multimedia card apparatus, the memory stick apparatus, the xD picture card apparatus, and the USB memory apparatus (serving as the memory card read/write device 31) or an apparatus to which a recording medium is installed.

Furthermore, the encoded audio data may be transferred and recorded to all of the above-described apparatuses.

Next, a process of reproducing audio with the image recording/reproducing apparatus 100 according to the first embodiment of the present invention (see FIG. 1) is described.

In accordance with the control of the CPU 27, encoded audio data is read out from the memory device 30 or the memory card read/write device 31, and is transferred to the memory 26 via the bus/I/O controller 23 and the memory/bus controller 25. The encoded audio data transferred to the memory 26 is decoded into digital audio data by using a program. Then, the analog image/audio signal generator LSI 24 converts the decoded digital audio data into analog audio data for enabling output from a speaker. Thereby, the converted analog audio data are output for allowing sound to be output from the speaker.

As alternatives for the MPEG 2 format and/or the MPEG 1 layer 2 format of Task A, and the MPEG 4 format and/or the MPEG 4-ACC format of Task B, other image encoding formats such as MPEG 1, and other audio encoding formats such as G.726, or Dolby Digital may be used.

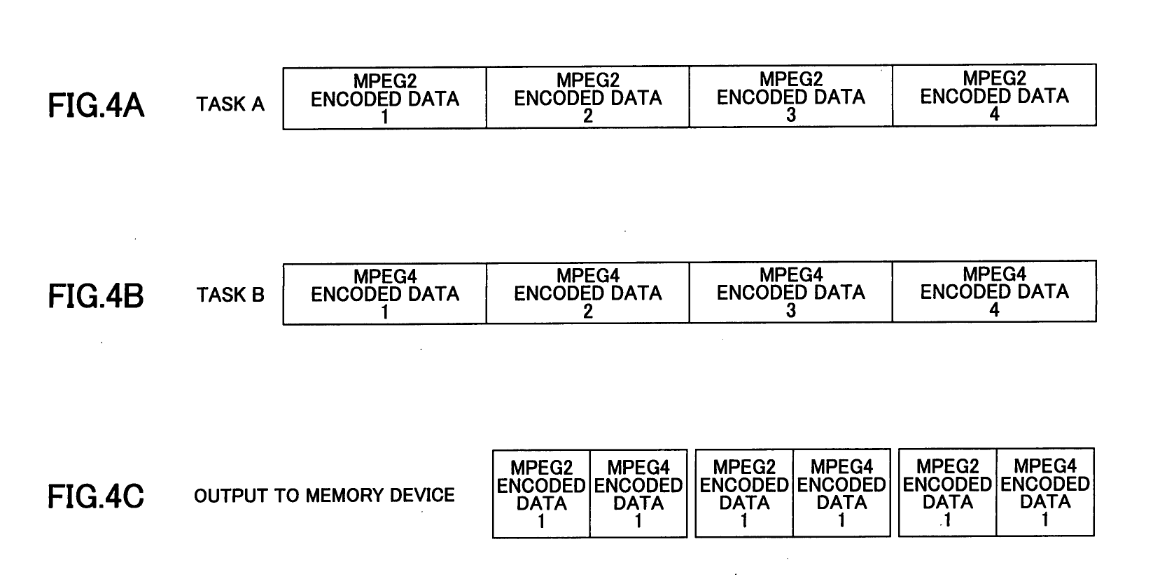

FIGS. 4A-4C are schematic diagrams for describing an outputting operation with respect to the memory device of the image recording/reproducing apparatus 100 according to the embodiment of the present invention. In FIGS. 4A-4C, time is illustrated in a horizontal direction of the drawings. It is to be noted that the recording process to a recording medium in the memory device 30 is not executed by alternately recording each of the data streams. Furthermore, the time required for the recording device 30 to record (write) encoded image/audio data in the encoding tasks is considerably faster than the time required for encoding.

FIG. 4A shows MPEG 2 stream data in an MPEG 2 data stream output from the image/audio encoding process of Task A, in which each stream data is stored in the memory 26 for a predetermined amount of time.

FIG. 4B shows MPEG 4 stream data in an MPEG 4 data stream output from the image/audio encoding process of Task B, in which each stream data is stored in the memory 26 for a predetermined amount of time, in the same manner shown in FIG. 4A.

FIG. 4C shows the output of data from the bus/I/O controller 23 to the memory device 30, in which MPEG 2 stream data and MPEG 4 stream data stored in the memory 26 are alternately output in order, to the memory device 30. This operation is repeated until recording of the series of data is completed.

[Second Embodiment]

Next, an image recording/reproducing apparatus (recording apparatus) 200 according to a second embodiment of the present invention is described.

The external view of the image recording/reproducing apparatus 200 according to a second embodiment of the present invention is the same as that of the image recording/reproducing apparatus 100 according to the first embodiment of the present invention shown in FIG. 2. The image recording/reproducing apparatus 200 according to a second embodiment of the present invention is slightly different from the image recording/reproducing apparatus 100 according to the first embodiment of the present invention from the aspects of internal composition and function.

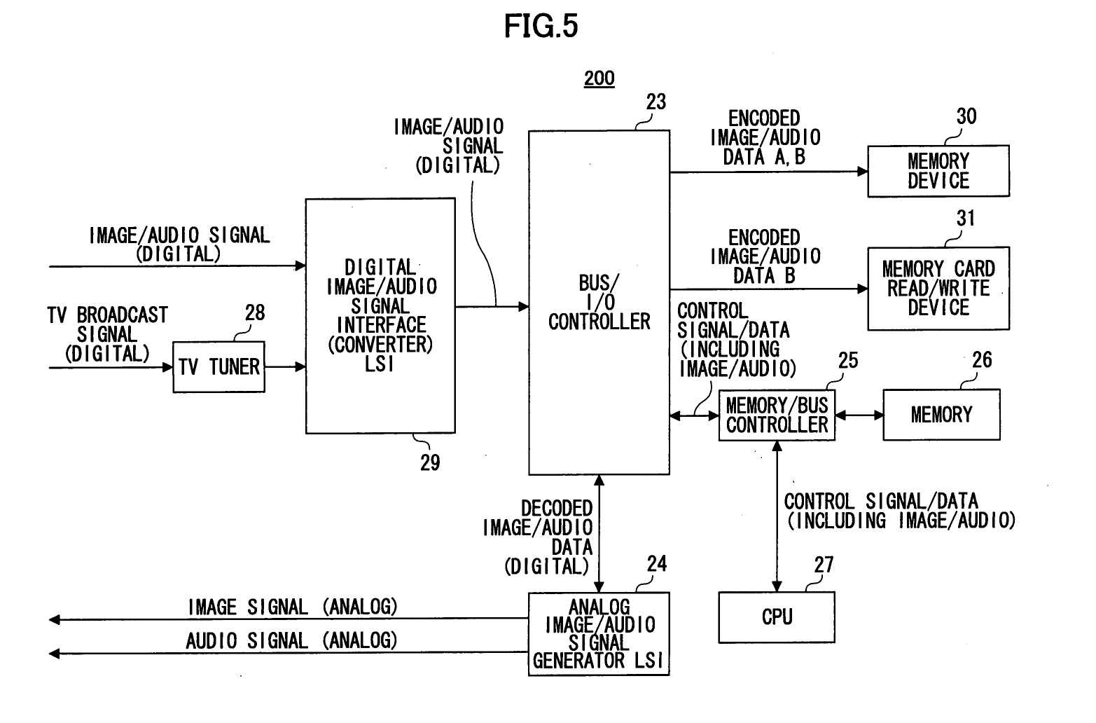

FIG. 5 is a block diagram showing an internal composition of the image recording/reproducing apparatus 200 according to the second embodiment of the present invention, in which like components are denoted by like numerals as of the first embodiment and will not be further explained.

The image recording/reproducing apparatus 200 according to the second embodiment of the present invention has a television (TV) tuner 28 and a digital image/audio signal interface (converter) LSI 29 as alternatives with respect to the above-described television (TV) tuner 20, the A/D converter 21, and the video decoder/interface LSI 22.

The TV tuner 28 receives digital TV broadcast waves in MPEG 2 stream format and inputs therein digital TV broadcast signals. The TV tuner 28 then generates digital TV broadcast image signals and digital TV broadcast audio signals in accordance with the digital TV broadcast signals. The generated digital TV broadcast image signals and the digital TV broadcast audio signals are output to the digital image/audio signal interface (converter) LSI 29.

The digital image/audio signal interface (converter) LSI 29 converts the digital TV broadcast image/audio signals from the TV tuner 20 and/or digital image/audio signals input from the external into a format applicable to the bus/I/O controller 23, and outputs the converted signals to the bus/I/O controller 23.

That is, in the image recording/reproducing apparatus 200 according to the second embodiment of the present invention, the bus/I/O controller 23, the TV tuner 28, and the digital image/audio signal interface (converter) LSI 29 function as inputting parts.

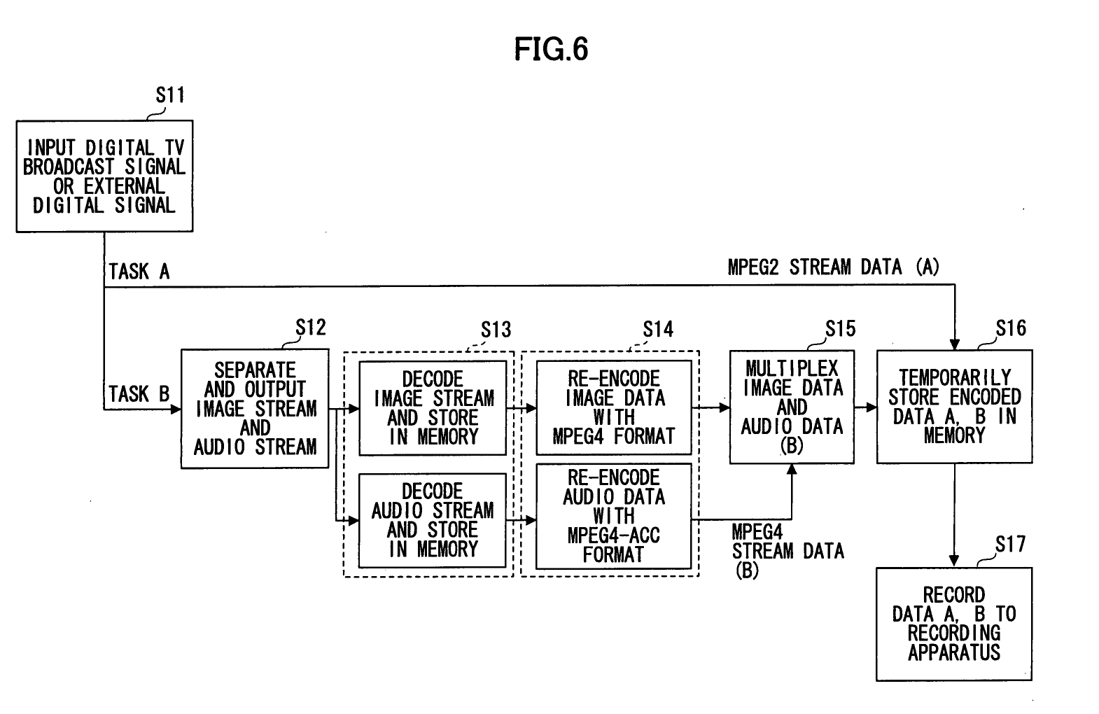

Next, a process for simultaneously recording image and audio with the image recording/reproducing apparatus 200 according to the second embodiment of the present invention (see FIG. 5) is described with reference to the flowchart shown in FIG. 6.

In accordance with the control of the CPU 27, digital TV broadcast signals are input when the TV tuner 28 receives digital TV broadcast waves transmitted in the form of MPEG 2 stream data (Step S11). Then, digital image signals and digital audio signals are generated from the digital TV broadcast signals, and are output to the digital image/audio signal interface LSI 29. In addition, digital signals (digital image/audio signals) may be input from the external to the digital image/audio signal interface LSI 29.

The digital image/audio signal interface LSI 29 converts the digital image/audio signals to a data format applicable to the interface of the bus/I/O controller interface 23, and outputs the converted digital image/audio signals to the bus/I/O controller interface 23. The digital image signals and the digital audio signals in MPEG 2 format are output to the memory 26 via the bus/I/O controller interface 23 and the memory/bus controller 25. In a case where it is determined that the digital image/audio signals can be recorded after executing copyright protection signal detection, in Task A, the digital image/audio signals in MPEG 2 format are temporarily stored in the memory 26 as is, that is, as MPEG 2 stream data (encoded data A) (Step S16).

Meanwhile, in Task B, the digital image/audio signals in MPEG 2 format output to the memory 26 are separated into image stream data and audio stream data (Step S12). Then, the image stream data is extracted and decoded in the memory, and the audio stream data is extracted in decoded in the memory (Step S13). Then, the decoded image stream data is re-encoded with MPEG 4 format, and the decoded audio stream data is re-encoded with MPEG 4-ACC format (Step S14). The re-encoded image stream data and audio stream data are multiplexed into a single stream data (Step S15). Then, the single stream data is temporarily stored in the memory 26 as MPEG 4 stream data (encoded data B) (Step S16).

Then, in Step S17, data A and B are alternately recorded in order, in uniform spans of time, to the memory device 30. That is, various types of encoded image/audio data are recorded to the memory device 30.

In a case where both the memory device 30 and the memory card read/write device 31 are set to have the encoded image/audio data recorded thereto, various types of encoded image/audio data are recorded to the memory device 30 and the memory card read/write device 31.

Furthermore, in a case of recording the encoded image/audio data to the memory card read/write device 31, the user may selectively read out a particular encoded image/audio data from the recording device 30, and transfer the particular encoded image/audio data to the memory card read/write device 31 to be recorded thereat. Furthermore, the user may also selectively read out a particular encoded image/audio data from the memory 26, and transfer the particular encoded image/audio data to the memory card read/write device 31 to be recorded thereat.

The user may selectively transfer and record the encoded image/audio data to any one of the optical disk, the PC card apparatus, the compact flash card apparatus, the smart media apparatus, the SD memory card/multimedia card apparatus, the memory stick apparatus, the xD picture card apparatus, and the USB memory apparatus (serving as the memory card read/write device 31) or an apparatus to which a recording medium is installed. Furthermore, the encoded image/audio data may be transferred and recorded to all of the above-described apparatuses.

Next, a process of simultaneously reproducing image and audio with the image recording/reproducing apparatus 200 according to the second embodiment of the present invention (see FIG. 5) is described.

In accordance with the control of the CPU 27, encoded image data and audio data are read out from the memory device 30 or the memory card read/write device 31, and is transferred to the memory 26 via the bus/I/O controller 23 and the memory/bus controller 25. The encoded image/audio data transferred to the memory 26 are decoded into digital image/audio data by using a program. Then, the analog image/audio signal generator LSI 24 converts the decoded digital image/audio data into analog image data for enabling display on a display (e.g. monitor) and analog audio data for enabling output from a speaker. Thereby, the converted analog image data and audio data are output for allowing images to be displayed on the display and sound to be output from the speaker.

Next, a process for recording image(s) using various (plural) encoded data with the image recording/reproducing apparatus 200 according to the second embodiment of the present invention (see FIG. 5) is described.

In accordance with the control of the CPU 27, digital TV broadcast signals are input when the TV tuner 28 receives digital TV broadcast waves transmitted in the form of MPEG 2 stream data. Then, digital image signals and digital audio signals are generated from the digital TV broadcast signals, and are output to the digital image/audio signal interface LSI 29. In addition, digital signals (digital image/audio signals) may be input from the external to the digital image/audio signal interface LSI 29.

The digital image/audio signal interface LSI 29 converts the digital image/audio signals to a data format applicable to the interface of the bus/I/O controller interface 23, and outputs the converted digital image/audio signals to the bus/I/O controller interface 23. The digital image signals and the digital audio signals in MPEG 2 format are output to the memory 26 via the bus/I/O controller interface 23 and the memory/bus controller 25. In a case where it is determined that the digital image/audio signals (MPEG 2 stream data) can be recorded after executing copyright protection signal detection, in Task A, digital image stream data is separated from the MPEG 2 stream data and is temporarily stored in the memory 26 as is, that is, as MPEG 2 image stream data (encoded data A).

Meanwhile, in Task B, digital image stream data is separated from the MPEG 2 stream data and is decoded in the memory. Then, the decoded image stream data is re-encoded with MPEG 4 format and is temporarily stored in the memory 26 as MPEG 4 image stream data (encoded data B).

Then, data A and B are alternately recorded in order, in uniform spans of time, to the memory device 30. That is, various types of encoded image data are recorded to the memory device 30.

In a case where both the memory device 30 and the memory card read/write device 31 are set to have the encoded image data recorded thereto, various types of encoded image data are recorded to the memory device 30 and the memory card read/write device 31.

Furthermore, in a case of recording the encoded image data to the memory card read/write device 31, the user may selectively read out a particular encoded image data from the recording device 30, and transfer the particular encoded image data to the memory card read/write device 31 to be recorded thereat. Furthermore, the user may also selectively read out a particular encoded image data from the memory 26, and transfer the particular encoded image data to the memory card read/write device 31 to be recorded thereat.

The user may selectively transfer and record the encoded image data to any one of the optical disk, the PC card apparatus, the compact flash card apparatus, the smart media apparatus, the SD memory card/multimedia card apparatus, the memory stick apparatus, the xD picture card apparatus, and the USB memory apparatus (serving as the memory card read/write device 31) or an apparatus to which a recording medium is installed.

Furthermore, the encoded image data may be transferred and recorded to all of the above-described apparatuses.

Next, a process of reproducing image(s) with the image recording/reproducing apparatus 200 according to the second embodiment of the present invention (see FIG. 5) is described.

In accordance with the control of the CPU 27, encoded image stream data is read out from the memory device 30 or the memory card read/write device 31, and is transferred to the memory 26 via the bus/I/O controller 23 and the memory/bus controller 25. The encoded image stream data transferred to the memory 26 is decoded into digital image data by using a program. Then, the analog image/audio signal generator LSI 24 converts the decoded digital image data into analog image data for enabling display on a display (e.g. monitor). Thereby, the converted analog image data is output for allowing images to be displayed on the display.

Next, a process for recording audio using various (plural) encoded data with the image recording/reproducing apparatus 200 according to the second embodiment of the present invention (see FIG. 5) is described.

In accordance with the control of the CPU 27, digital TV broadcast signals are input when the TV tuner 28 receives digital TV broadcast waves transmitted in the form of MPEG 2 stream data. Then, digital image signals and digital audio signals are generated from the digital TV broadcast signals, and are output to the digital image/audio signal interface LSI 29. In addition, digital signals (digital image/audio signals) may be input from the external to the digital image/audio signal interface LSI 29.

The digital image/audio signal interface LSI 29 converts the digital image/audio signals to a data format applicable to the interface of the bus/I/O controller interface 23, and outputs the converted digital image/audio signals to the bus/I/O controller interface 23. The digital image signals and the digital audio signals in MPEG 2 format are output to the memory 26 via the bus/I/O controller interface 23 and the memory/bus controller 25. In a case where it is determined that the digital image/audio signals (MPEG 2 stream data) can be recorded after executing copyright protection signal detection, in Task A, digital audio stream data is separated from the MPEG 2 stream data, is encoded with MPEG 1 Layer 2 format, and is temporarily stored in the memory 26 (encoded data A).

Meanwhile, in Task B, digital audio stream data is separated from the MPEG 2 stream data and is decoded in the memory. Then, the decoded audio stream data is re-encoded with MPEG 4-ACC format and is temporarily stored in the memory 26 (encoded data B).

Then, data A and B are alternately recorded in order, in uniform spans of time, to the memory device 30. That is, various types of encoded audio data are recorded to the memory device 30.

In a case where both the memory device 30 and the memory card read/write device 31 are set to have the encoded audio data recorded thereto, various types of encoded audio data are recorded to the memory device 30 and the memory card read/write device 31.

Furthermore, in a case of recording the encoded audio data to the memory card read/write device 31, the user may selectively read out a particular encoded audio data from the recording device 30, and transfer the particular encoded audio data to the memory card read/write device 31 to be recorded thereat. Furthermore, the user may also selectively read out a particular encoded audio data from the memory 26, and transfer the particular encoded audio data to the memory card read/write device 31 to be recorded thereat.

The user may selectively transfer and record the encoded audio data to any one of the optical disk, the PC card apparatus, the compact flash card apparatus, the smart media apparatus, the SD memory card/multimedia card apparatus, the memory stick apparatus, the xD picture card apparatus, and the USB memory apparatus (serving as the memory card read/write device 31) or an apparatus to which a recording medium is installed.

Furthermore, the encoded audio data may be transferred and recorded to all of the above-described apparatuses.

Next, a process of reproducing audio with the image recording/reproducing apparatus 200 according to the second embodiment of the present invention (see FIG. 5) is described.

In accordance with the control of the CPU 27, encoded audio data is read out from the memory device 30 or the memory card read/write device 31, and is transferred to the memory 26 via the bus/I/O controller 23 and the memory/bus controller 25. The encoded audio data transferred to the memory 26 is decoded into digital audio data by using a program. Then, the analog image/audio signal generator LSI 24 converts the decoded digital audio data into analog audio data for enabling output from a speaker. Thereby, the converted analog audio data is output for allowing sound to be output from the speaker.

As alternatives for the MPEG 2 format and/or the MPEG 1 layer 2 format of Task A, and the MPEG 4 format and/or the MPEG 4-ACC format of Task B, other image encoding formats such as MPEG 1, and other audio encoding formats such as G.726, or Dolby Digital may be used.

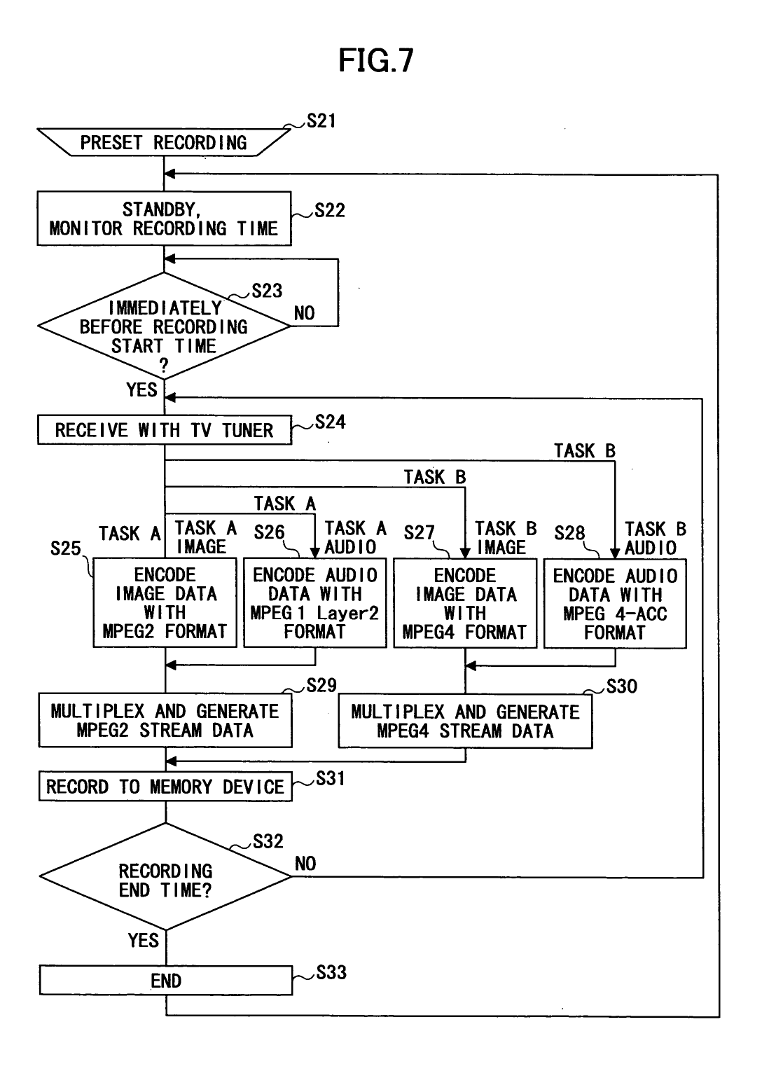

FIG. 7 is a flowchart for describing a preset recording operation with the image recording/reproducing apparatus 100 according to the first embodiment of the present invention shown in FIG. 1.

In Step S21, the user presets information (details) for recording as in a typical presetting procedure with, for example, a hard disk recorder or a VTR. After the information for recording is preset, the CPU 27 stands by for the preset recording operation, and monitors the preset recording time by checking its internal timer (Step S22). The CPU 27 determines whether the time is immediately before the preset recording start time (Step S23). When the time is not immediately before the preset recording start time (NO in Step S23), the process returns to Step S22.

When the time is immediately before the preset recording start time (YES in Step S23), the reception of TV broadcast signals is started by turning on the power of the entire system and setting a preset channel to the TV tuner 20 (Step S24). Then, in Task A of Step S25, image data of the image signals output from the TV tuner 20 is encoded with MPEG 2 format, to thereby generate MPEG 2 encoded image data. In Task A of Step S26, audio data of the audio signals output from the TV tuner 20 is encoded with MPEG 1 Layer 2 format, to thereby generate MPEG 2 Layer 1 encoded audio data.

Meanwhile, in Task B in Step S27, image data of the image signals output from the TV tuner 20 is encoded with MPEG 4 format, to thereby generate MPEG 4 encoded image data. In Task B of Step S28, audio data of the audio signals output from the TV tuner 20 is encoded with MPEG 4-ACC format, to thereby generate MPEG 4-ACC encoded audio data.

Then, in Step S29, the MPEG 2 encoded image data and the MPEG 2 Layer 1 encoded audio data are multiplexed to be temporarily stored in the memory 26 as MPEG 2 stream data. In Step S30, the MPEG 4 encoded image data and the MPEG 4-ACC encoded audio data are multiplexed to be temporarily stored in the memory 26 as MPEG 4 stream data. Then, in Step S31, the MPEG 2 stream data and the MPEG 4 stream data are stored in the memory device 30.

Then, in Step S32, the CPU 27 determines whether the time is recording end time. When the time is not yet the recording end time (NO in Step 32), the operation is continued by returning to Step S24. When the time has reached the recording end time (YES in Step 32), the operation is finished and returns to Step S22 (Step S33).

Other than not performing the encoding process in Task A, the above-described preset recording operation can be applied in the same manner with respect to the image recording/reproducing apparatus 200 according to the second embodiment of the present invention shown in FIG. 5.

It is to be noted that the memory device according to the embodiments of the present invention may be applied to, for example, a desk top type computer or a notebook type computer.

In consequence, with the present invention, various encoded image/audio data encoded with various encoding formats can be recorded simultaneously with the CPU without requiring any complex operation, thereby enabling only necessary data stored in the memory device to be transferred to the memory card, and reproduced with a portable reproduction apparatus. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the hard disk to be transferred to the memory card, and reproduced with a portable reproduction apparatus. In addition, the problem of limited recording time of the memory card due to the large amount of data in the hard disk can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the optical disk to be transferred to the memory card, and reproduced with a portable reproduction apparatus. In addition, the problem of limited recording time of the memory card due to the large amount of data in the optical disk can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the hard disk to be transferred to the PC card flash memory or the PC card type hard disk, and reproduced with a portable reproduction apparatus having a PC card slot. In addition, the problem of limited recording time of the PC card flash memory or the PC card type hard disk due to the large amount of data in the memory device can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the hard disk to be transferred to the compact flash card or the compact flash card type hard disk, and reproduced with a portable reproduction apparatus having a compact flash card slot. In addition, the problem of limited recording time of the compact flash card or the compact flash card type hard disk due to the large amount of data in the memory device can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the hard disk to be transferred to the smart media, and reproduced with a portable reproduction apparatus having a smart media slot. In addition, the problem of limited recording time of the smart media due to the large amount of data in the memory device can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the hard disk to be transferred to the SD memory card, and reproduced with a portable reproduction apparatus having an SD memory card slot. In addition, the problem of limited recording time of the SD memory card due to the large amount of data in the memory device can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the hard disk to be transferred to the multimedia card, and reproduced with a portable reproduction apparatus having a multimedia card slot. In addition, the problem of limited recording time of the multimedia card due to the large amount of data in the memory device can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the hard disk to be transferred to the memory stick, and reproduced with a portable reproduction apparatus having a memory stick slot. In addition, the problem of limited recording time of the memory stick due to the large amount of data in the memory device can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the hard disk to be transferred to the xD picture card, and reproduced with a portable reproduction apparatus having an xD picture card slot. In addition, the problem of limited recording time of the xD picture card due to the large amount of data in the memory device can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the hard disk to be transferred to the USB memory, and reproduced with a portable reproduction apparatus having a USB memory port. In addition, the problem of limited recording time of the USB memory due to the large amount of data in the memory device can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the optical disk to be transferred to the PC card flash memory or the PC card type hard disk, and reproduced with a portable reproduction apparatus having a PC card slot. In addition, the problem of limited recording time of the PC card flash memory or the PC card type hard disk due to the large amount of data in the memory device can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the optical disk to be transferred to the compact flash card or the compact flash card type hard disk, and reproduced with a portable reproduction apparatus having a compact flash card slot. In addition, the problem of limited recording time of the compact flash card or the compact flash card type hard disk due to the large amount of data in the memory device can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the optical disk to be transferred to the smart media, and reproduced with a portable reproduction apparatus having a smart media slot. In addition, the problem of limited recording time of the smart media due to the large amount of data in the memory device can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the optical disk to be transferred to the SD memory card, and reproduced with a portable reproduction apparatus having an SD memory card slot. In addition, the problem of limited recording time of the SD memory card due to the large amount of data in the memory device can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the optical disk to be transferred to the multimedia card, and reproduced with a portable reproduction apparatus having a multimedia card slot. In addition, the problem of limited recording time of the multimedia card due to the large amount of data in the memory device can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the optical disk to be transferred to the memory stick, and reproduced with a portable reproduction apparatus having a memory stick slot. In addition, the problem of limited recording time of the memory stick due to the large amount of data in the memory device can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the optical disk to be transferred to the xD picture card, and reproduced with a portable reproduction apparatus having an xD picture card slot. In addition, the problem of limited recording time of the xD picture card due to the large amount of data in the memory device can be solved. In addition, other types of encoding formats can be easily applied by changing of the program.

Furthermore, various encoded image/audio data encoded with various encoding formats can be recorded simultaneously with the CPU without requiring any complex operation, thereby enabling only necessary data stored in the optical disk to be transferred to the USB memory, and reproduced with a portable reproduction apparatus having a USB memory port. In addition, the problem of limited recording time of the USB memory due to the large amount of data in the memory device can be solved. In addition, other types of encoding formats can be easily applied by changing of the program.

Further, the present invention is not limited to these embodiments, but various variations and modifications may be made without departing from the scope of the present invention.

1. A recording apparatus comprising:
an inputting part for inputting image signals;
a generating part for generating various encoded image data encoded with various encoding formats from the image signals input from the inputting part; and
a recording part for recording the various encoded image data generated from the generating part.

2. A recording apparatus comprising:
an inputting part for inputting image signals and audio signals;
a generating part for generating various encoded image data and various encoded audio data encoded with various encoding formats from the image signals and audio signals input from the inputting part; and
a recording part for recording the various encoded image data and the various encoded audio data generated from the generating part.

3. A recording apparatus comprising:
an inputting part for inputting image signals;
a generating part for generating various encoded image data encoded with various encoding formats from the image signals input from the inputting part;
a first recording part for recording the various encoded image data generated from the generating part; and
a second recording part for recording a designated one of the various encoded image data generated from the generating part.

4. The recording apparatus as claimed in claim 3, wherein the first recording part is a hard disk apparatus, and the second recording part is an optical disk apparatus.

5. The recording apparatus as claimed in claim 3, wherein the first recording apparatus is a hard disk apparatus, and the second recording apparatus is a memory card apparatus.

6. The recording apparatus as claimed in claim 3, wherein the first recording part is a hard disk apparatus, and the second recording part is a USB memory apparatus.

7. The recording apparatus as claimed in claim 3, wherein the first and second recording apparatuses are optical disk apparatuses.

8. The recording apparatus as claimed in claim 3, wherein the first recording part is an optical disk apparatus, and the second recording part is a memory card apparatus.

9. The recording apparatus as claimed in claim 3, wherein the first recording part is an optical disk apparatus, and the second recording part is a USB memory apparatus.

10. A recording apparatus comprising:
an inputting part for inputting image signals and audio signals;
a generating part for generating various encoded image data and various encoded audio data encoded with various encoding formats from the image signals and the audio signals input from the inputting part;
a first recording part for recording the various encoded image data and the various encoded audio data generated from the generating part; and
a second recording part for recording a designated one of the various encoded image data and the various encoded audio data generated from the generating part.

11. A recording method comprising the steps of:
a) inputting image signals;
b) generating various encoded image data encoded with various encoding formats from the image signals input in step a); and
c) recording the various encoded image data generated in step b).

12. A recording method comprising the steps of:
a) inputting image signals and audio signals;
b) generating various encoded image data and various encoded audio data encoded with various encoding formats from the image signals and audio signals input in step a); and
c) recording the various encoded image data and the various encoded audio data generated in step c).

13. A recording method comprising the steps of:
a) inputting image signals;
b) generating various encoded image data encoded with various encoding formats from the image signals input in step a);
c) recording the various encoded image data generated in step b) to a first recording part; and
d) recording a designated one of the various encoded image data generated in step b) to a second recording part.

14. The recording method as claimed in claim 13, wherein the first recording part is a hard disk apparatus, and the second recording part is an optical disk apparatus.

15. The recording method as claimed in claim 13, wherein the first recording apparatus is a hard disk apparatus, and the second recording apparatus is a memory card apparatus.

16. The recording method as claimed in claim 13, wherein the first recording part is a hard disk apparatus, and the second recording part is a USB memory apparatus.

17. The recording method as claimed in claim 13, wherein the first and second recording apparatuses are optical disk apparatuses.

18. The recording method as claimed in claim 13, wherein the first recording part is an optical disk apparatus, and the second recording part is a memory card apparatus.

19. The recording method as claimed in claim 13, wherein the first recording part is an optical disk apparatus, and the second recording part is a USB memory apparatus.

20. A recording method comprising the steps of:
a) inputting image signals and audio signals;
b) generating various encoded image data and various encoded audio data encoded with various encoding formats from the image signals and the audio signals input in step a);
c) recording the various encoded image data and the various encoded audio data generated in step b) to a first recording part; and
d) recording a designated one of the various encoded image data and the various encoded audio data generated in step b) to a second recording part.
